(19) United States
(12) Patent Application Publication
(10) Pub. No.: US 2011/0275735 A1
(43) Pub. Date: Nov. 10, 2011

(54) HVAC COMPONENTS WITH ANTI-MICROBIAL PROPERTIES

(75) Inventors: Jeffrey R. Robbins, Ann Arbor, MI (US); Louis Dodyk, Marion, IN (US)

(73) Assignee: Magna International Inc., Aurora, ON (CA)

(21) Appl. No.: 13/138,195

(22) PCT Filed: Jan. 25, 2010
(86) PCT No.: PCT/US2010/022000

§ 371 Date: Jul. 19, 2011

Related U.S. Application Data
(60) Provisional application No. 61/146,996, filed on Jan. 23, 2009.

(51) Int. Cl. C08K 3/10

(52) U.S. Cl. 523/122

(57) ABSTRACT

The present invention is directed to a sheet moulded compound having a high fire and smoke rating as well as providing anti-microbial properties. The sheet moulded compound is useful in forming products where it is desirable to have high fire and smoke ratings in addition to preventing the growth or accumulation of microbes on the product. Particular applications include, but are not limited to using the sheet moulded compound to form walls and other structure members or components of a furnace, carriers for heating\cooling systems which are often subject to exposure to outside elements and standing water. Other suitable products including other components of a heating and cooling ventilation system can also be formed and within the scope of the present invention.

### CROSS-REFERENCE TO RELATED APPLICATIONS

This application claims the benefit of U.S. Provisional Application No. 61/146,996, filed Jan. 23, 2009.

### FIELD OF THE INVENTION

The present invention relates generally to the formation of sheet moulded compounds for use in building materials. More particularly, the present invention relates to a sheet moulded compound that exhibits desirable anti-fire, anti-smoke and anti-microbial properties.

### BACKGROUND OF THE INVENTION

Products such as furnaces or other heating and cooling products must meet rigorous standards and customer requirements for flame and smoke resistance. Organizations such as Underwriter's Laboratory (UL) perform testing and certification of such products. In producing polymeric components for use in furnaces and related applications, for example, a number of UL tests may be performed prior to sale of such products, including the following: UL 94 (Tests for Flammability of Plastic Materials for Parts in Devices and Appliances); UL 746A (Polymeric Materials—Short Term Property Evaluations); UL 746B (Polymeric Materials—Long Term Property Evaluations); UL 746C (Polymeric Materials—Use in Electrical Equipment Evaluations); UL 746D (Polymeric Materials—Fabricated Parts); UL 723 (Test for Surface Burning Characteristics of Building Materials (ASTM E-84/NFPA 255/Steiner Tunnel)); and UL 1995 (Heating and Cooling Equipment—OEM Product Requirements).

Because moisture may build up at certain times within furnaces and other heating/cooling products, it may be desirable to include some way of preventing growth and development of undesirable microbes (e.g., bacteria, mold, fungus, viruses, etc.), which could be passed through the air of a residence or other building if allowed to grow or accumulate unchecked.

Accordingly, it would be advantageous to provide polymeric materials that could be used as components of furnaces and other heating/cooling products that can both pass the rigorous standards for flame and smoke resistance while providing an added benefit of resistance to the growth and development of undesirable microbes.

### SUMMARY OF THE INVENTION

The present invention is directed to a sheet moulded compound having a high fire and smoke rating as well as providing anti-microbial properties. The sheet moulded compound is useful in forming products where it is desirable to have high fire and smoke ratings in addition to preventing the growth or accumulation of microbes on the product. Particular applications include, but are not limited to using the sheet moulded compound to form walls and other structure members or components of a furnace, carriers for heating\cooling systems which are often subject to exposure to outside elements and standing water. Other suitable products including other components of a heating and cooling ventilation system can also be formed and within the scope of the present invention.

The sheet moulded compound has a base material, an anti-fire material in which one exemplary embodiment includes aluminum trihydrate material present in a range of about 5% to about 50% weight of the sheet moulded compound. The sheet moulded compound also includes an anti-microbial material, which in another exemplary embodiment is an inorganic silver zeolite material. The inorganic silver zeolite material is present in a general range of about 0.3% to about 1% weight of the sheet moulded compound. In another exemplary embodiment of the present invention, an anti-smoke material is included in the sheet moulded compound. The anti-smoke material can include members of the acrylic group of materials as well as intumescent materials. When the anti-smoke material, anti-fire material and anti-microbial material are all present in the sheet moulded compound, the end result is a compound that meets high standards of fire and smoke safety as well as effectively preventing the growth or accumulation of microbes on the material.

### BRIEF DESCRIPTION OF THE DRAWINGS

FIG. 1 is a schematic diagram of an in-line mixing system according to an exemplary embodiment.

FIG. 2 is a schematic diagram of a machine that is used to form an sheets of material that can later be used to form sheet molded composite (SMC) components according to an exemplary embodiment.

FIG. 3A shows a perspective view of a furnace wall assembly made with the sheet moulded compound in accordance with the present invention.

FIG. 3B shows a partially broken perspective view of the furnace wall of FIG. 3A.

FIG. 3C shows an additional partially broken perspective view of the furnace wall assembly of FIG. 3A.

FIG. 4A is a perspective view of another furnace assembly having walls made from sheet moulded compound.

FIG. 4B is an exploded perspective view of FIG. 4A.

FIG. 5 is an angled perspective view of a carrier module for a heating or cooling unit made from sheet moulded compound.

### DETAILED DESCRIPTION OF THE PREFERRED EMBODIMENTS

According to an exemplary embodiment, a polymeric material having flame and smoke resistant properties includes an anti-microbial additive to prevent growth of microbes. The polymeric material is a thermosetting polymeric material, and may be based, for example, on a polyester or vinyl ester resin system. The polymeric material may be used to form a sheet molded compound (SMC) material for use in a variety of applications as will be discussed below in greater detail.

The production SMC material includes an A side (which includes the bulk of the resin, fillers and minors), a B side (which normally includes pigments and thickening agents), and a reinforcing material (e.g., glass, carbon). During the sheet forming process, the ratio between the two feed streams for the A side and the B side is typically in the range of 10:1 up to 50:1 (A:B). Additionally, a “C-stream” could be added to the compounding operation for additional component additions. The anti microbial component is normally added to the A side, although it could be added in the B or C side depending on the specific compounding equipment. Likewise, this same anti microbial component could be introduced into any liquid resin system with flammability resistance using a process such as resin transfer molding (RTM), vacuum infusion or open molding.

According to an exemplary embodiment, a typical SMC component may have the following composition as shown in Table 1 below.

TABLE 1

| | Structural | Class A |
|---|---|---|
| A-Side (paste) | | |
| Polyester/Vinylester Resin | 15-20% | 20-30% |
| Low Profile Additive | 8-10% | 5-8% |
| Catalyst | 0.3-0.5% | 0.3-0.5% |
| Mold Release | 1.0% | 1.0% |
| Filler | 45-50% | 5-35% |
| Other Additives | 1.0% | 1.0-2.0% |
| B-Side | | |
| Thickener | 0.5% | 1.0% |
| Resin & Pigment carried | | |
| in a resin as above. | | |
| Common ratio is 38 | | |
| parts A to 1 part B | | |
| Glass | 25-30% | 35-65% |

According to an exemplary embodiment, the antimicrobial additive is a non-migrating inorganic material and is added as a powder into an SMC paste composition used to form the polymeric material. According to another exemplary embodiment, the anti microbial may be preblended with other minors as a master batch, either solid or liquid. The additive may be added at a relatively low dose and processed as a “minor” throughout the standard SMC material compounding and molding.

According to an exemplary embodiment, the polymeric material having the anti-microbial additive may be used in a variety of applications where there is a tendency for growth of bacteria, mold, and/or fungus to develop (e.g., in applications where moisture may be present). According to a particular exemplary embodiment, the material is used to form components for use in heating and cooling systems and related components. As a non-limiting example, the materials may be used to form polymeric walls or floors of a furnace.

The inventors have determined that when the antimicrobial additive is used in conjunction with an SMC material, it is effective to combat growth and development of a variety of undesirable bacteria, mold, and/or fungus types, including, but not necessarily limited to escherichia coli (EC), staphylococcus aureus (SA), pseudomoas aeruginosa (PA), bacillus subtilis (BS), aspergillus niger, aureobasidium pululans, penicillium pinophium, chaetomium blobosum, and gliocladium virens (e.g., where the JIS Z2801-2000 test standard was used for testing effectiveness against bacteria and the ASTM G 21-96 test was used for testing effectiveness against fungus and mold).

According to an exemplary embodiment, the antimicrobial additive is an inorganic silver zeolite based antimicrobial that can be processed at temperatures greater than 500 degrees Celsius. Zeolites are crystalline aluminosilicates with fully cross-linked open framework structures. The framework has a negative charge, which is balanced by cations such as sodium, silver, and the like. The cations are mobile and exchangeable by, for example H⁺/H₂O. According to a particular exemplary embodiment, the additive is commercially available from Ciba Specialty Chemicals, Inc. of under the trade name IRGAGUARD® B 5000, which is a silver-zinc-zeolite having the composition M_{2/n}.Al₂O₃.xSiO₂.yH₂O.

The antimicrobial additive may be used in the polymeric material at a level that is effective to provide the desired antimicrobial properties for the final component. According to an exemplary embodiment, the antimicrobial additive is provided at a level of 0.3 weight percent. According to other exemplary embodiments, the antimicrobial additive may be provided at other suitable levels (e.g., 0.5%, 1.0%, etc.).

One advantageous feature of the antimicrobial additive is that it has non-migrating properties such that it does not retreat into the bulk material or advance to the surface of the bulk material in the finished product. Thus, the antimicrobial additive will be distributed relatively evenly throughout the material.

Another feature of the polymeric material is that because of demands placed on the components and the requirements of various rating organizations (e.g., Underwriters Laboratories), the polymeric material has been designed to provide enhanced resistance to flame and smoke. One possibility for retarding flame is to incorporate a halogen such as bromine into the polymeric material. However, one disadvantage of the use of halogens is that they tend to produce smoke when exposed to flames. Instead of using a halogen, then, according to an exemplary embodiment, the polymeric material described herein uses an aluminum trihydrate (ATH) material. The ATH material includes water molecules as part of the composition, and when exposed to elevated temperatures, the water breaks free and acts to extinguish the flame (thus giving the components made from the polymeric material a desirable self-extinguishing property).

According to an exemplary embodiment, the polymeric material may have as a base material any conventional material used in the manufacture of SMC products, with added components to provide enhanced flame and/or smoke resistance and resistance to growth and development of undesirable microbes. For example, the base material may be based on an unsaturated polyester resin system (e.g., a propylene glycol maleate, an isophthalic resin, or a terephthalic resin), an unsaturated vinyl ester resin system, a dicyclopentadiene resin system, or combinations of the aforementioned resins.

The base material may include components such as one or more low profile thermoplastic additives (e.g., a saturated polyester, polyvinyl acetate, low density polyethylene, polystyrene, etc.); a styrene monomer; one or more viscosity reducers (e.g., a stearic acid, a fatty acids, viscosity reducers commercially available from BYK of Germany); one or more inhibitors for inhibiting the onset of a crosslinking reaction in the polymer (e.g., BHT, PBQ, etc.); one or more UV stabilizers (e.g., absorbers, hinder amine light stabilizers (HALS), etc.); one or more organic peroxide catalysts (e.g., Trigonox, Luperox, etc.); one or more mold release materials (e.g., zinc stearate, calcium stearate, or blends thereof); a thickening agent (e.g., earth oxides such magnesium oxide, calcium oxide, magnesium hydroxide; urethane; etc.); a coloring pigment (e.g., carbon black or various other coloring agents); a reinforcement material (e.g., glass, carbon, Kevlar, or other suitable reinforcements). A carrier film may also be used for processing the materials.

The polymeric material also includes components intended to provide enhanced flame and/or smoke resistance in the finished product. For example, the material may include one or more of an acrylic monomer (e.g., butyl acrylate, ethyl acrylate, methyl acrylate or methyl methacrylate); an intumescent (e.g., hydrates, sodium silicate, graphite, phosphates, etc.); and an aluminum trihydrate (ATH) material. According to an exemplary embodiment, the ATH material may be added to both the A side and the B side streams. According to a particular exemplary embodiment, the polymeric material includes between approximately 0.5 and 10.0 weight percent acrylic monomer, between approximately 30 and 70 weight percent ATH material; and between approximately 0.5 and 2.0 weight percent intumescent.

The polymeric material also includes components intended to provide enhanced resistance to growth and development of undesirable microbes. One non-exclusive example of such a material is an inorganic silver zeolite based antimicrobial material such as IRGAGUARD® B 5000, commercially available from Ciba Specialty Chemicals, Inc. According to an exemplary embodiment, the polymeric material includes between approximately 0.3 and 1.0 weight percent of the antimicrobial material, although it should be understood that according to other exemplary embodiments, other loading levels may be used. According to a particular exemplary embodiment, the polymeric material includes 0.3 weight percent of the antimicrobial material. According to another particular exemplary embodiment, the polymeric material includes 0.5 weight percent of the antimicrobial material. According to another particular exemplary embodiment, the polymeric material includes 1.0 weight percent of the antimicrobial material.

The weight percentages of the various components of the polymeric material may be adjusted for a particular exemplary embodiment. The materials that provided enhanced antimicrobial and flame/smoke resistance may be used in conjunction with any suitable polymeric material according to various exemplary embodiments. For example, the materials that provided enhanced antimicrobial and flame/smoke resistance may be used with any polymeric material that is intended for use in situations where such properties are desired, such as HVAC systems such as furnaces, air conditioning units, and the like.

The flame/smoke resistant and antimicrobial components of the polymeric material are configured to function in the desired manner regardless of whether or not a UV stabilizer is provided as a part of the base polymeric material.

It should be understood by those reviewing the present disclosure that according to other exemplary embodiments, the formula for the polymeric material having an antimicrobial additive may differ from that shown above. For example, other additives may be substituted for various components of the polymeric material, and various components may be provided in any suitable loading level that is suitable for a particular desired application.

The antimicrobial additive may be added at any suitable point in the manufacturing process (e.g., in an A-stream, a B-stream, a C-stream, or any other stream or in more than one of such streams).

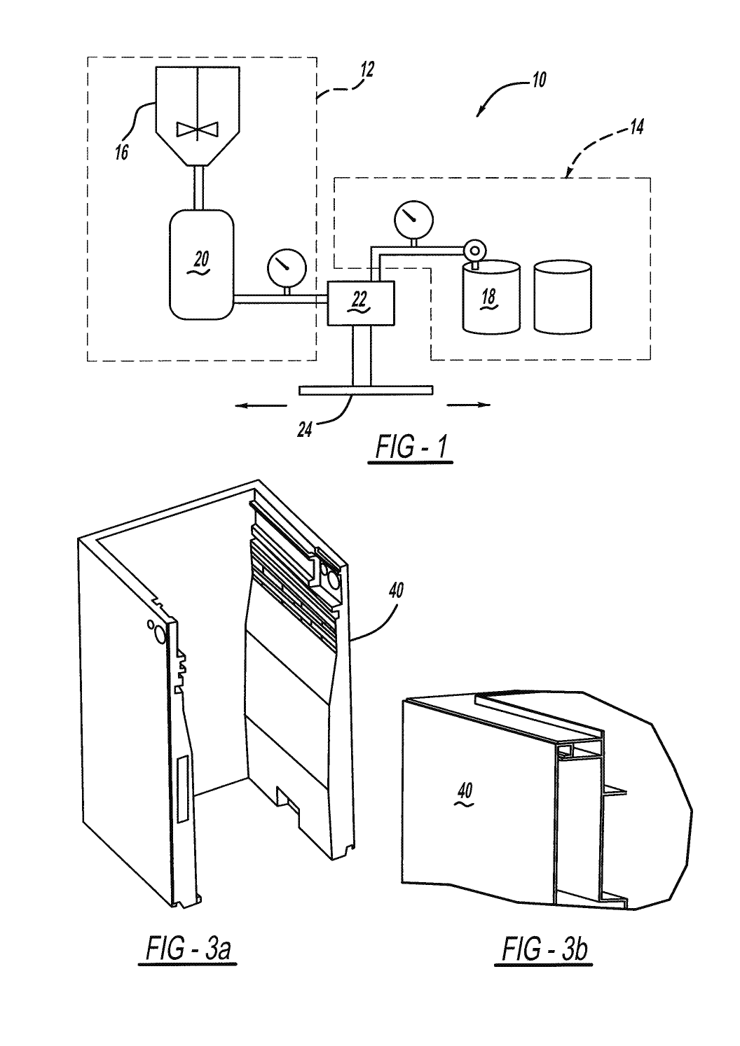

FIG. 1 is a schematic diagram of an in-line mixing system 10 used in the production of an SMC material according to an exemplary embodiment. The mixing system 10 has an A-side 12 and a B-side 14. In the A-side 12, there is a mixing tank 16 where components forming what is commonly referred to as the paste of the SMC are combined and mixed. The components of the paste include, but are not limited to, resin, low profile additives, catalyst, mold release, fillers and other additives. On the B-side 14, components commonly referred to as a thickener are mixed. The material includes what is referred to as a thickener and resin with any desired pigmentation as well as other additives such as, but not limited to, the mixing of anti-microbial material. It is within the scope of the invention to not have all of the above mentioned components depending on the need of the particular application. The thickener material is held within a holding tank 18 on the B-side. The A-side 12 further includes a holding tank 20 that holds the paste material prior to being blended with the material from the B-side 14. The paste is mixed in a dynamic mixer 22 with thickener material from the holding tank 18. After the material is mixed, it starts to become SMC material which is quickly moved to one or more doctor boxes 24.

It is also possible for additional streams or side referred to as a “C-side” to be introduced to the dynamic mixer. A C-side is typically used when you have an odd ratio of A and B being mixed. Therefore, implementing a C-side will depend on the need in a particular application.

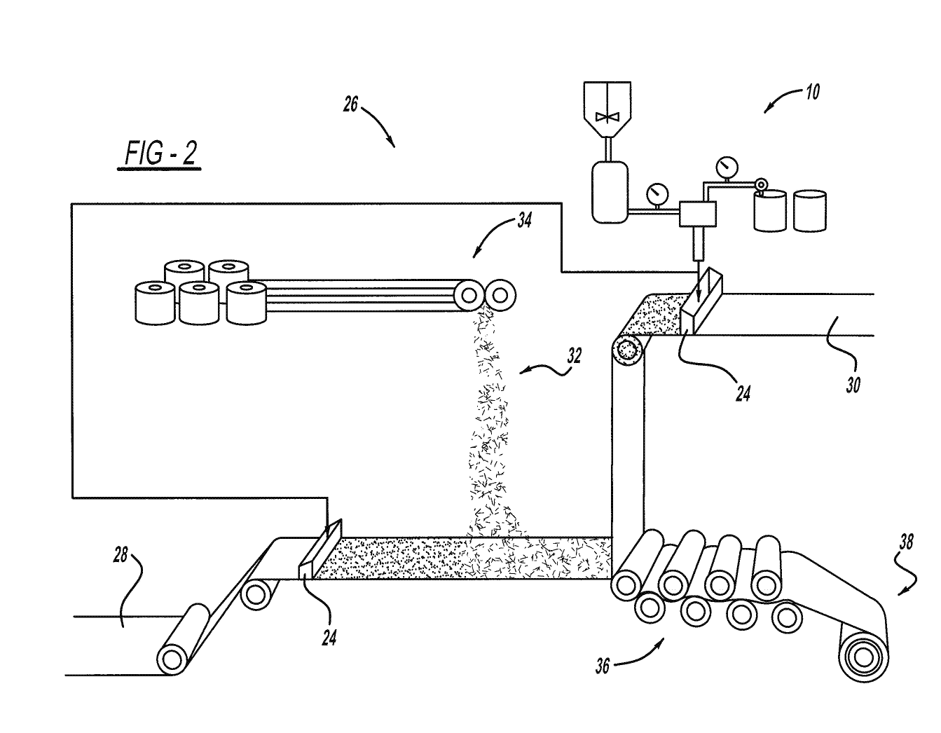

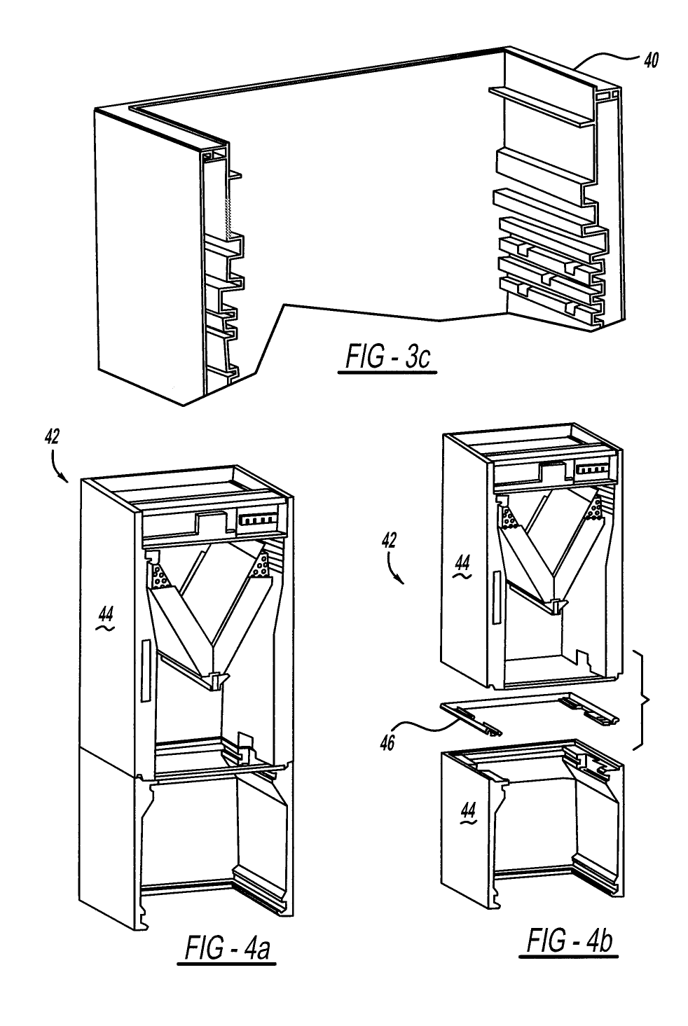

FIG. 2 is a schematic diagram of a machine 26 used to form sheets of SMC material according to an exemplary embodiment. The machine 26 receives SMC material from the in-line mixing system 10 wherein the material is distributed to the doctor boxes 24. As shown, the machine 26 has more than one doctor box that receives SMC material from the in-line mixing system 10. The SMC material from the in-line mixing system 10 is fed through the doctor boxed 24 on to one of two sheets of carrier film 28, 30. One sheet of carrier film 28 receives the SMC material 24 and down stream receives chopped glass 32 from a glass chopping apparatus 34. The chopped glass 32 is applied to the surface of the carrier film 28 with the SMC material and then moves further downstream wherein the second sheet of carrier film 30 with the SMC material is then laid over the top of the first sheet with the chopped glass 32 on the surface. At this point the layers of the structure become a completed sheet moulded compound which is then fed through a serpentine belt system 36 where the chopped glass 32 is pressed into the SMC compound set on each of the two sheets of carrier film 28, 30. The SMC compound sheet is then collected at a roller 38 or it may be packaged in sheet form. The roll 38 of SMC material can later be fed into a forming line to where the sheets are cut and then formed into products such as those shown in FIGS. 3-5.

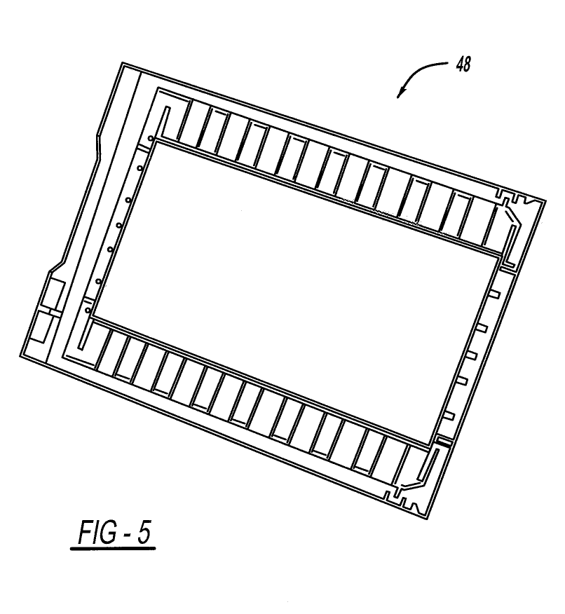

FIGS. 3A-3C show various views of the walls of a furnace 40 that have been formed out of the SMC material described above. The furnace components are formed by compression molding, but it is possible for other techniques to be used. FIGS. 4A-4B show another sample of a three piece furnace 42 having the walls of the furnace 44 formed out of the SMC material in accordance with the present invention. Additionally, the furnace walls 42 also have a separator plate 46 that is also formed from SMC composite material. The walls may be formed as one piece or they can be several walls connected together. FIG. 5 depicts a one piece carrier unit 48 formed out of the SMC material and is suitable for use on the roof of a building for acting as a carrier for a heating and cooling system. In addition to the above described products, it is also possible for the SMC material to be formed into various other products spanning a large variety of markets including transportation, electrical, consumer and industrial markets. Specific applications include, but are not limited to, doors, hoods, roofing components, valve covers, bathtubs, shower stalls, basketball backboards, circuit breakers, electrical boxes, housings for electrical applications and manway covers in industrial settings.

The walls (e.g., the “box” or enclosure) and other structural members or components of the furnace, which will obviously be exposed to elevated temperatures, may be formed from the SMC sheet material, and will provide enhanced resistance to growth and development of undesirable microbes (e.g., mold, fungus, bacteria, etc.) that may tend to accumulate in areas where moisture may be present. The SMC component as described herein also has flame and smoke resistant properties, allowing metal components to be replaced with the SMC material for a more lightweight and inexpensive design.

It should be understood that the application of the SMC material should not be limited to the particular components shown in FIGS. 3-5. There may be other components of a furnace or heating/cooling system that would also benefit from the use of the SMC material, and it is intended that all such components fall within the scope of the present application.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

### Example 1

An evaluation was undertaken to evaluate the ability of antimicrobial additives for the prevention the potential growth of microbes in or on a polymeric material (i.e., an SMC material). Testing was performed to determine efficacy of three levels of an antimicrobial additive in the material.

Feedback from customer surveys indicated several microbes as the most critical: escherichia coli (EC), staphylococcus aureus (SA), pseudomoas aeruginosa (PA), and bacillus subtilis (BS). The JIS Z2801-2000 test standard was used for testing purposes.

The additive chosen for evaluation was IRGAGUARD® B 5000, commercially available from Ciba Specialty Chemicals, Inc. This additive is EPA listed as suitable for HVAC applications. A ladder was created at the low and high end of the historical additive range as well as an excessive value to ensure complete prevention. Different samples were made with 0.3%, 0.5%, and 1.0% by weight of the antimicrobial additive.

The appropriate bacteria were introduced to the samples at a certified laboratory and a microbial count was made, then covered by a standard film. The control was a standard inert covered film. Per the test method, all specimens were incubated at 35 degrees Celsius for 24 hours.

The efficacy of the additives was determined as a logarithmic ratio (R) of the count before and after the test. In this test, R values of >2 indicate efficacy. An R value of 5.0 indicates 99.9999% effectiveness. Results are shown in Table 2 below.

TABLE 2

| | Control | | Samples | |
|---|---|---|---|---|
| | Initial | Ending | # of | |
| Microbe | # of | # of | Microbe | Antimicrobial |
| ID | Microbes | Microbes | after Test | Activity (R) |
| EC | 2.4 EE 5 | 1.4 EE 7 | <10 | 6.1 |
| SA | 2.3 EE 5 | 2.0 EE 6 | <10 | 5.3 |
| PA | 2.1 EE 5 | 3.3 EE 6 | <10 | 5.5 |

During testing, it was noted that all ladder values of additives showed identical reduction in microbes, and so only one value is shown representing all cases, for simplicity. The value of <10 is an industry standard which means zero, but is simply written as though a few were not counted.

As reflected in the above table, use of the additive in the SMC material was effective against escherichia coli (EC), staphylococcus aureus (SA), and pseudomoas aeruginosa (PA).

### Example 2

Samples of the sheet moulded compound (SMC) material are prepared. All of these samples have a base material, anti-fire material and an anti-microbial material. Additionally, some of the samples are prepared with anti-smoke material. The samples are arranged in groups. In Group 1, several samples were prepared having either inorganic silver zeolite material present or microban material present as the anti-microbial material. The anti-microbial material (i.e., either inorganic silver zeolite material or microban material) is within ranges of about 0.3% to about 1% weight of the SMC compound, 0.5% to 0.7% weight of the SMC compound, and about 0.05% weight of the SMC compound. Multiple samples are created within the above described ranges. The samples of Group 1 additionally contain an anti-fire material. The anti-fire material is added to various samples of Group 1 at various increment levels that are found to be in the range of about 5% to about 55% weight of the SMC compound, about 5% to about 60% weight of the SMC compound and about 45% to about 65% weight of the SMC compound.

In Group 2, several samples are created that contain the same materials and amounts as the samples found in Group 1 with additional anti-smoke material being added. The anti-smoke material in Group 2 is an intumescent material. The intumescent material is one or more materials selected from a group comprising hydrates, sodium silicate, graphite and phosphates. Samples of Group 2 are prepared having all of the aforementioned intumescents present in a range between about 0.5% to about 2.0% weight of the sheet moulded compound.

In Group 3, several samples are created that contain the same materials and amounts as the samples found in Group 1 with additional anti-smoke material being added. The anti-smoke material in Group 3 is an acrylic monomer. Several samples are created using acrylic monomers including butyl acrylate, ethyl acrylate, methyl acrylate or methyl methacrylate. Several samples are created of the aforementioned monomers with several samples of each acrylic compound prepared in the range of about 0.5% to about 10% weight of the sheet moulded compounds.

In Group 4, several samples are created that contain the same materials an amounts as the samples found in Group 1 with the anti-smoke material being specifically various combinations of aluminum trihydrate material The anti-fire material was added in various combinations to create several samples with the total amount of anti-fire material at various increment levels that are found to be in the range of about 5% to about 55% weight of the SMC compound, about 5% to about 60% weight of the SMC compound and about 45% to about 65% weight of the SMC compound.

With regard to the base materials used in all of the samples prepared under Example 2, the base materials all include one or more of the following: resins, low profile additives, catalysts, mold releasers, thickeners, chopped glass and one or more carrier films. Furthermore, the base materials do not contain any calcium carbonate filler material, methyl methacrylate, saturated polyester low profile additives and halogens.

The samples of SMC material made in Examples 1 and 2 are found to exhibit a high test reading for anti-fire and anti-smoke properties. Additionally, the samples containing anti-microbial material exhibit high ratings for anti-microbial activities. With regard to fire and smoke testing, it is common for materials to be rated by organizations such as Underwriters Laboratories (UL), The American Society for Testing and Materials (ASTM), The American National Standards Institute (ANSI) and the Japanese Industrial Standards (Jis). All of these organizations rate various materials for a given purpose and the tests and ratings are know in the art and widely accepted.

With regard to the UL and ASTM standards, the samples prepared are found to meet what is commonly referred to as the UL 723 or ASTM E-84 fire and smoke ratings. These ratings involve a test for surface burning characteristics of building materials. The test is required where there are large parts attached to a building penetration such as a plenum (rooftop HVAC), or when the part is located inside of a building such as part of a furnace. The test involves using a Steiner tunnel which compares flame spread over a part surface and the developed smoke density to other materials. The results of the test analyze the flame spread index (FSI) and the smoke developed index (SDI) of the material. The results are often shown as a unit or ratio of FSI\SDI. Reference calibration for zero (0) FSI is a material known as cement board and for one hundred (100) is red oak material. All the samples formed in Example 2 meet the UL 723, ASTM E-84 fire and smoke rating with a flame spread index of about 10 to about 100 and a smoke rating of about 20 to about 400 depending on the sample tested.

In order for the UL 723, ASTM E-84 test to be carried out, samples are loaded in to a Steiner tunnel which has a large flame that is blown horizontally through a portion of the tunnel to simulate burning of material in a ceiling of a building. At the egress end of the tunnel, the smoke produced is analyzed in order to determine the smoke rating for the material based upon the amount of light obstruction due to the presence of smoke. Material that undergoes the UL 723, ASTM E-84 test and achieves a favorable fire and smoke rating is considered suitable for use in building materials that are used in air systems and furnaces within a building.

Additionally, the sheet moulded compound in accordance with the present invention met the requirements for the UL 94 VO test and 5VA test. These tests are referred to as a vertical flame test wherein samples of the material are hung vertically and placed in a flame from a Bunsen burner for a period of time. The burn patterns are then analyzed and the material is rated. The specific conditions for performing this test are set forth in the UL standards and are well known in the art. The samples of sheet moulded compound in Example 2 meet the approval of the test guidelines in the 5VA and VO tests.

In addition to fire and smoke rating, the material made in accordance with the present invention has also achieved favorable anti-microbial rating. With regard to the anti-microbial tests, two common tests are referred to as the J is Z 2801:2000, v1 2005 test for bacteria and the ASTM G 21-96 test for various fungi. The bacteria test determines whether the material being tested prevents or stops the growth of bacteria including Escherichia coli, staphylococcus aureus, pseudomonas aeruginosa, and bacillus subtilis. The ASTM G 21-96 test for fungi assesses the samples ability to prevent the growth of fungi and specifically tests the samples ability to prevent the growth of aspergillus niger, aureobasidium pullulans, penicillium pinophilum, chaetomium globosum and gliocladium virens. The test for bacteria and the test for fungi are carried out by placing samples of the selected bacteria or fungi in a known quantity directly on to the sample. A protective layer or covering is placed over the test site to prevent any contamination. The bacteria or fungi are placed on to the sample in a medium that encourages growth and provides nutrients to the organisms. Per the test method, all of the specimens are incubated at 35 degrees Celsius for 24 hours. The bacteria or fungi samples are examined to determined whether or not growth has occurred, been maintained or whether the bacteria or fungi have died. The test results showed that the material actually functions to kill the bacteria and fungi to the point that the amount of bacteria or fungi at the end of the test was a value of <10, which is an industry standard which means zero, but is certainly written as though if you were not counted. All of the samples formed in Example 2 are found to meet or exceed the JIS Z 2801:2000, v1 2005 standard for antibacterial qualities and the ASTM G 21-96 anti-fungal rating.

It is important to note that the construction and arrangement of the components and materials shown and described with respect to the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

The description of the invention is merely exemplary in nature and, thus, variations that do not depart from the gist of the invention are intended to be within the scope of the invention. Such variations are not to be regarded as a departure from the spirit and scope of the invention.

1. A sheet moulded compound comprising:
base materials;
anti-fire materials; and
anti-microbial materials.

2. The sheet moulded compound of claim 1 wherein said anti-microbial materials have an inorganic silver zeolite material.

3. The sheet moulded compound of claim 1 wherein said anti-microbial materials are present in an amount that is about 0.3% to about 1% weight of the sheet moulded compound.

4. The sheet moulded compound of claim 1 wherein said anti-microbial materials are present in an amount that is about 0.5% to about 0.7% weight of the sheet moulded compound.

5. The sheet moulded compound of claim 1 wherein said anti-microbial materials are present in an amount that is about 0.5% weight of the sheet moulded compound.

6. The sheet moulded compound of claim 1 wherein said anti-fire materials include aluminum trihydrate material.

7. The sheet moulded compound of claim 6 wherein said aluminum trihydrate material is present in an amount between about 5% to about 55% weight of the sheet moulded compound.

8. The sheet moulded compound of claim 6 wherein said aluminum trihydrate material is present in an amount between about 5% to about 60% weight of the sheet moulded compound.

9. The sheet moulded compound of claim 6 wherein said aluminum trihydrate material is present in an amount between about 45% to about 65% weight of the sheet moulded compound.

10. The sheet moulded compound of claim 1 further comprising anti-smoke materials.

11. The sheet moulded compound of claim 10 wherein said anti-smoke materials have at least one of the flowing materials:
acrylic monomer or an intumescent.

12. The sheet moulded compound of claim 10 wherein said anti-smoke materials further include an acrylic monomer present in a range in between about 0.5% to about 10% weight of the sheet moulded compound.

13. The sheet moulded compound of claim 12 wherein said acrylic monomer is one or more of the group comprising:
butyl acrylate, ethyl acrylate, methyl acrylate or methyl methacrylate.

14. The sheet moulded compound of claim 10 wherein said anti-smoke materials have an intumescent present in a range between about 0.5% to about 2.0% weight of the sheet moulded compound.

15. The sheet moulded compound of claim 14 wherein said intumescent is one or more selected from the group comprising hydrates, sodium silicate, graphite and phosphates.

16. The sheet moulded compound of claim 1 wherein said sheet moulded compound is formed into walls of a furnace, duct work, plenums and carrier modules for heating and cooling systems.

17. The sheet moulded compound of claim 1 wherein the base materials include one or more of the following: resins, low profile additives, catalysts, mold releasers, thickeners, chopped glass and one or more carrier films and combinations thereof, wherein said base materials further consists essentially of a base materials that is absent calcium carbonate filler material, methyl methacrylate, saturated polyester low profile additives and halogens.

18. The sheet moulded compound of claim 1 wherein said sheet moulded compound meets the Underwriter's Laboratory's requirements for a UL 723 rating having a flame spread index rating of about 10 to about 100 and a smoke rating index of about 20 to about 400, and said sheet moulded compound material meets the American Society for Testing and Materials ASTM E-84 fire and smoke ratings.

19. The sheet moulded compound of claim 18 wherein the moulded compound material further has a Japanese industrial standard rating of JIS Z 2801:2000, v1 2005 for antibacterial qualities and an American standard test method rating of ASTM G 21-96 anti-fungal rating.

20. The sheet moulded compound of claim 1 wherein said sheet moulded compound meets the Underwriters Laboratory's requirements for a UL-94 rating having a VA5 vertical burn rating and VO vertical burn rating.

21. A sheet moulded compound comprising:
base materials;
anti-smoke materials;
anti-fire materials present in an amount in one range selected from the group comprising about 5% to about 65% weight of the sheet moulded compound; and
anti-microbial materials.

22. The sheet moulded compound of claim 21 wherein the anti-microbial materials include an inorganic silver zeolite material.

23. The sheet moulded compound of claim 21 wherein said anti-microbial materials are about 0.3% to about 1% weight of the sheet moulded compound.

24. The sheet moulded compound of claim 21 wherein said anti-microbial materials are about 0.5% to about 0.7% weight of the sheet moulded compound.

25. The sheet moulded compound of claim 21 wherein said anti-fire materials include aluminum trihydrate material.

26. The sheet moulded compound of claim 21 wherein said sheet moulded compound meets the Underwriter's Laboratory's requirements for a UL 723 rating having a flame spread index rating of about 10 to about 100 and a smoke rating index of about 20 to about 400, and said sheet moulded compound material meets the American Society for Testing and Materials ASTM E-84 fire and smoke ratings.

27. The sheet moulded compound of claim 26 wherein the moulded compound material further has a Japanese industrial standard rating of JIS Z 2801:2000, v1 2005 for antibacterial qualities and an American standard test method rating of ASTM G 21-96 anti-fungal rating.

28. The sheet moulded compound of claim 21 wherein said sheet moulded compound meets the Underwriters Laboratory's requirements for a UL-94 rating having a VA5 vertical burn rating and VO vertical burn rating.

29. The sheet moulded compound of claim 21 wherein the base materials include one or more of the following: resins, low profile additives, catalysts, mold releasers, thickeners, chopped glass and one or more carrier films and combinations thereof, wherein said base materials further consists essentially of base materials that is absent calcium carbonate filler material, methyl methacrylate, saturated polyester low profile additives and halogens.

30. A sheet moulded compound comprising:
base materials;
an aluminum trihydrate material present in an amount in one range selected from the group comprising about 5% to about 50% weight of the sheet moulded compound; and
an inorganic silver zeolite material present in an amount selected comprising about 0.3% to about 1% weight of the sheet moulded compound.

31. The sheet moulded compound of claim 30 wherein said sheet moulded compound is formed into walls of a furnace, duct work, plenums and carrier modules for heating and cooling systems.

32. The sheet moulded compound of claim 30 further comprising anti-smoke materials.

33. The sheet moulded compound of claim 32 wherein said anti-smoke materials are at least one of the following materials:
an acrylic or intumescent.

34. The sheet moulded compound of claim 32 wherein said anti-smoke materials further comprise an acrylic monomer present in a range between about 0.5% to about 10% weight of the sheet moulded compound.

35. The sheet moulded compound of claim 34 wherein said acrylic monomer is one selected from the group comprising:
butyl acrylate, ethyl acrylate, methyl acrylate or methyl methacrylate.

36. The sheet moulded compound of claim 32 wherein said anti-smoke material is an intumescent present in a range between about 0.5% to about 2% weight of the sheet moulded compound.

37. The sheet moulded compound of claim 36 wherein said intumescents is one or more selected from the group comprising hydrates, sodium silicate, graphite and phosphates.

38. The sheet moulded compound of claim 30 wherein the base materials include one or more of the following: resins, low profile additives, catalysts, mold releasers, thickeners, chopped glass and one or more carrier films and combinations thereof, wherein said base materials further consists essentially of a base materials that is absent calcium carbonate filler material, methyl methacrylate, saturated polyester low profile additives and halogens.
